(19) United States
(12) Patent Application Publication
(10) Pub. No.: US 2012/0012094 A1
(43) Pub. Date: Jan. 19, 2012

(54) FREESTANDING BARBECUE

(76) Inventor: Michael J. Halperin, Cape Town (ZA)

(21) Appl. No.: 13/203,679

(22) PCT Filed: Feb. 2, 2010
(86) PCT No.: PCT/IB2010/000192

§ 371 Date: Aug. 26, 2011

(30) Foreign Application Priority Data
Apr. 6, 2009 (ZA) 2009/02397

(51) Int. Cl. A47J 37/00

(52) U.S. Cl. 126/25 R

(57) ABSTRACT

A freestanding barbecue is provided comprising a base, an upright central column extending from the base and supporting at its operatively upper end a central region of a generally horizontal cooking support that is typically a cooking grid or a shallow dished impervious cooking surface. An ash pan encircles the central column and is vertically adjustable in position with respect to the upper end of the column and thus the cooking support. Preferably, a lever arrangement is fitted to the column for effecting vertical adjustment of the ash pan. The ash pan preferably has a central sleeve that serves to guide the ash pan relative to the central column and is supported on a collar that is movable relative to the column. The freestanding barbecue is preferably collapsible in which instance the cooking support and ash pan are removable from the central column that in turn is removable from the base. The column is conveniently collapsible by being made in a plurality of collinear parts.

### PRIORITY CLAIM

This application claims priority to PCT/IB2010/000192 filed Feb. 2, 2010; which claims priority to South African Serial No. 2009/02397 filed Apr. 6, 2009.

### FIELD OF THE INVENTION

This invention relates to a freestanding barbecue and, more particularly, but not necessarily exclusively, to a freestanding barbecue that is collapsible and easily packed for transport and storage purposes.

### BACKGROUND OF THE INVENTION

Numerous different freestanding barbecues are available and many of them are capable of collapsing for transport and storage purposes. Many of these either do not provide for adequate height adjustment of a cooking grid above the coals supported in an ash pan (sometimes referred to as a fire basket as well as by various other names) or, alternatively, a mechanism for effecting a height adjustment, especially when a hot fire is present in the ash pan, is difficult or dangerous to operate.

In the instance of freestanding barbecues that are collapsible, the packed form of the barbecue is very often not convenient for transport and storage purposes, especially not for the purpose of manually carrying the packed barbecue from one place to another.

### OBJECT OF THE INVENTION

It is an object of this invention to provide a freestanding barbecue that addresses, at least to some extent, shortfalls that applicant perceives in presently available barbecues.

### SUMMARY OF THE INVENTION

In accordance with this invention there is provided a freestanding barbecue comprising a base, an upright central column extending from the base and supporting at its operatively upper end a central region of a generally horizontal cooking support, and an ash pan encircling the central column and being vertically adjustable in position with respect to the upper end of the column.

Further features of the invention provide for a lever arrangement to be fitted to the column for effecting the vertical adjustment of the ash pan; for the ash pan to have a central sleeve that serves to guide the ash pan relative to the central column; for the ash pan to be supported on a collar that is movable relative to the column; for the cooking support to be a cooking grid that is optionally interchangeable with an impervious dished cooking surface (known in South Africa as a skottel braai); for the cooking grid or dished cooking surface to carry a central downwardly extending spigot that is operatively received in a socket in the upper end of the column; and for the base and ash pan to be of generally circular shape in plain view and of approximately the same diameter.

Still further features of the invention provide for the freestanding barbecue to be collapsible in which instance the cooking support and ash pan are removable from the central column that in turn is removable from the base; for the column to be collapsible either by being made in a plurality, typically two, collinear parts or by being telescopically extensible, for the collapsed column and cooking support to be receivable in the ash pan with the base serving as a kind of lid; and for a carrying bag to form a part of the freestanding barbecue assembly for receiving the collapsed and packed barbecue for transport and storage purposes.

In order that the invention may be more fully understood, one embodiment thereof will now be described with reference to the accompanying drawings.

### BRIEF DESCRIPTION OF THE DRAWINGS

FIG. 1 is a schematic exploded isometric view of one embodiment of collapsible barbecue according to the invention; and,

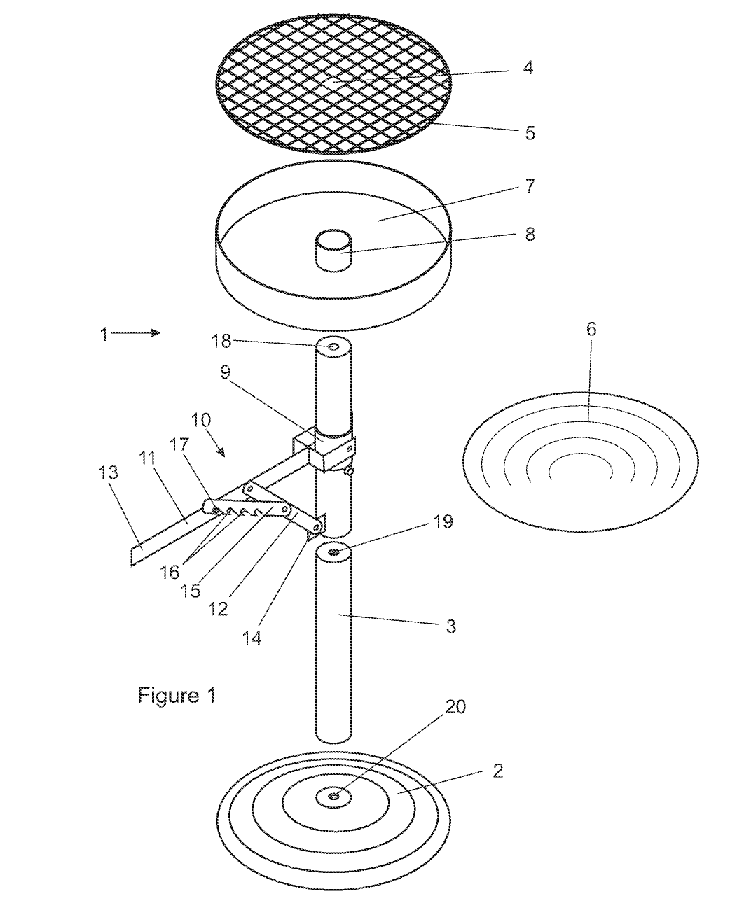

FIG. 2 is as a schematic elevation thereof.

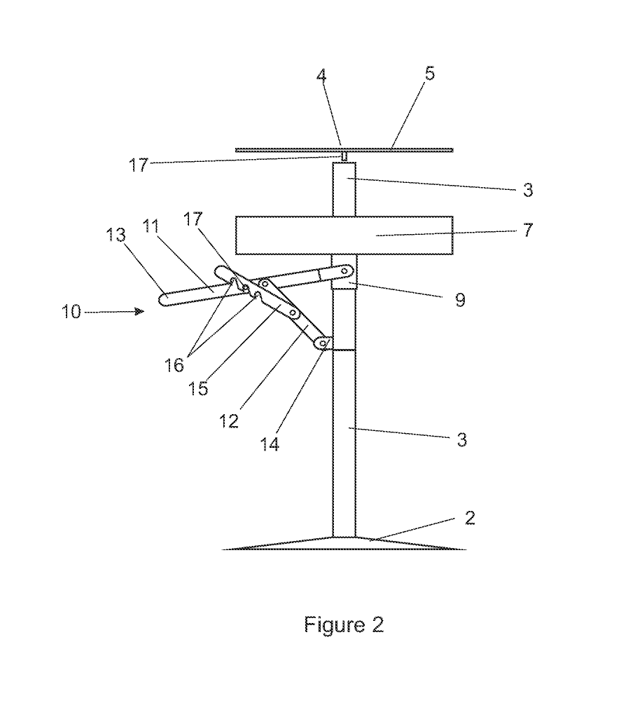

### DETAILED DESCRIPTION OF THE PREFERRED EMBODIMENT

In the embodiment of the invention illustrated in the drawings, a collapsible freestanding barbecue, generally indicated by numeral (1), comprises a squat conical pressed metal base (2), an upright central column (3) extending, in the operative condition, from the base with its upper end supporting a central region (4) of a circular generally horizontal cooking support. The cooking support may assume the form of a cooking grid (5) or an impervious shallow dished cooking surface (6) (of the general type widely known in South Africa as a skottel braai). Preferably, a collapsible barbecue is provided with both of such cooking supports that can be used interchangeably according to requirements.

A circular ash pan (7) encircles the central column with a central sleeve (8) serving as a guide for vertical movement of the ash pan relative to the column. The ash pan, in its operative position, is supported on a collar (9) that is movable relative to the column by means of a lever arrangement generally indicated by numeral (10) such that it, and accordingly the ash pan, is vertically adjustable in position with respect to the upper end of the column and thus the cooking support.

The lever arrangement, in this embodiment of the invention, comprises a manually operable operating lever (11) pivotally attached at one end to the collar and to a fulcrum lever (12) intermediate its ends. The other and free end (13) of the operating lever is for manual manipulation. The opposite end of the fulcrum lever is pivotally attached to an anchor point (14) fixed to the column approximately half way up its height. A latching link (15) is pivotally attached to the central region of the fulcrum lever and has a series of notches (16) in its lowermost edge that cooperate with a projection (17) on the operating lever outwards on the fulcrum lever. The collar can accordingly be supported by the lever arrangement in a variety of different vertical positions with the column therefore supporting the ash pan at different heights relative to the cooking support. Adjustment of the height of the ash pan is easily achieved simply by manipulating the outermost end (13) of the operating lever.

In this embodiment of the invention the freestanding barbecue is collapsible and, this being so, the cooking grid and dished cooking surface each carry a downwardly extending spigot (17) that is operatively received in a socket (18) in the upper end of the column. With the cooking support removed from the upper end of the column the ash pan can simply be lifted off the upper end of the column as it is not attached thereto in any way, being simply supported on the collar.

The column, in this instance, is composed of two collinear parts of equal length with the operatively upper one having the anchor point (14) secured to its lower end and therefore carrying the lever arrangement (10) and associated collar (9). The two parts of the column are releasably attachable in coaxial relationship by means of a screw threaded socket (19) in the end of the lower part of the column and a co-operating screw threaded stud (not shown) on the co-operating end of the upper part of the column. Similarly, the base is provided with a screw threaded socket (20) that receives a screw threaded stud (not shown) carried on the lowermost end of the lower part of the column. Any other suitable fastening arrangement can be employed.

Also, in this instance, the two parts of the collapsed column and at least the cooking grid are dimensioned to be receivable in the ash pan with the base serving as a lid in order to form a generally closed container housing the loose components of the freestanding barbecue. A dedicated carrying bag (not shown) forms a part of the freestanding barbecue assembly for receiving the collapsed and packed barbecue in order to facilitate transport and storage thereof. The carrying bag is provided with any required shoulder straps, carrying handles or the like.

It will be understood that, in use, with the freestanding barbecue in the erected condition, a fire can be lit in the ash pan generally with the latter in its lowermost position. As and when cooking is to be carried out, the height of the ash pan can be adjusted by manipulating the outer end of the operating lever so that the desired temperature can be achieved beneath the cooking support.

Numerous variations may be made to the embodiment of the invention described above without departing from the scope hereof.

1. A freestanding barbecue comprising a base, an upright central column extending from the base and operatively supporting at its operatively upper end a central region of a generally horizontal cooking support, and an ash pan encircling the central column and being vertically adjustable in position with respect to the upper end of the column.

2. A freestanding barbecue as claimed in claim 1 in which a lever arrangement is fitted to the column for effecting vertical adjustment of the ash pan.

3. A freestanding barbecue as claimed in claim 1 in which the ash pan has a central sleeve that serves to guide the ash pan relative to the central column.

4. A freestanding barbecue as claimed in claim 1 in which the ash pan is supported on a collar that is movable relative to the column.

5. A freestanding barbecue as claimed in claim 1 in which the cooking support is selected from a cooking grid and an impervious dished cooking surface.

6. A freestanding barbecue as claimed in claim 1 in which the cooking support carries a central downwardly extending spigot that is operatively received in a socket in the upper end of the column.

7. A freestanding barbecue as claimed in claim 1 in which the base and ash pan are of generally circular shape in plan view and of approximately the same diameter.

8. A freestanding barbecue as claimed in claim 1 in which the freestanding barbecue is collapsible and the cooking support and ash pan are removable from the central column that is in turn removable from the base.

9. A freestanding barbecue as claimed in claim 8 in which the column is collapsible by being made in a plurality of releasable collinear parts.

10. A freestanding barbecue as claimed in claim 8 in which the collapsed column and cooking support are receivable in the ash pan with the base serving as a kind of lid.

11. A freestanding barbecue as claimed in claim 8 in which a carrying bag forms a part of the freestanding barbecue assembly for receiving the collapsed and packed barbecue for transport and storage purposes.
